(19) United States
(12) Patent Application Publication
(10) Pub. No.: US 2025/0112694 A1
(43) Pub. Date: Apr. 3, 2025

(54) OPTICAL PULSE GENERATOR AND GENERATION METHOD

(71) Applicant: Nippon Telegraph and Telephone Corporation, Tokyo (JP)

(72) Inventors: Atsushi TANIGUCHI, Musashino-shi, Tokyo (JP); Hideki Nishizawa, Musashino-shi, Tokyo (JP); Kazuaki OBANA, Musashino-shi, Tokyo (JP)

(21) Appl. No.: 18/729,208

(22) PCT Filed: Jan. 25, 2022
(86) PCT No.: PCT/JP2022/002583

§ 371 Date: Jul. 16, 2024

(51) Int. Cl. H04B 10/073; H04B 10/54

(52) U.S. Cl. CPC H04B 10/073; H04B 10/54

(57) ABSTRACT

A light pulse generation device includes a light intensity modulator 2 that outputs light pulses in which a signal intensity of a photocarrier output by a light source 1 is modulated in accordance with a magnitude of a drive signal with an operation bias point as the center, a measurement unit 3 that measures an inter-pulse phase component that is an amplitude between the light pulses, a bias control unit 4 that controls the operation bias point on the basis of a magnitude of the inter-pulse phase component, and a drive signal control unit 5 that controls the magnitude of the drive signal on the basis of the magnitude of the inter-pulse phase component. The drive signal control unit 5 controls the drive signal such that an amplitude of the drive signal is twice an amplitude between a maximum value and a minimum value of a transmission characteristic of the light intensity modulator 2.

### TECHNICAL FIELD

The present invention relates to a light pulse generation device and a generation method for generating a light pulse having a high repetition rate and a short pulse width.

### BACKGROUND ART

In an optical communication system, when a signal is transmitted by a light pulse intensity modulation scheme, it is effective to shorten the pulse width of a light pulse to be transmitted in order to suppress spreading of the pulse due to dispersion of fiber.

Generation of a light pulse mainly include a direct modulation scheme of directly modulating an electric signal to light and an external modulation scheme of modulating an optical signal by external modulation.

In the direct modulation scheme, since a high-speed signal is directly modulated, there is a problem that phase fluctuation (phase chirp) due to wavelength fluctuation occurs. Meanwhile, as an external modulation scheme using an electro-optical effect, there are an electro-absorption type light intensity modulator and a Mach-Zehnder type light intensity modulator (hereinafter referred to as MZ type). Among the MZ types, a push-pull type intensity modulation in which driving is performed by applying a voltage signal having an opposite phase to a phase modulation unit of a waveguide is suitable for high-speed communication because frequency chirp can be suppressed.

As a light pulse generation device using an MZ type light intensity modulator, a method is known in which an operation bias point of an light intensity modulator is set such that transmittance of the light intensity modulator is maximized, and a sinusoidal wave or a rectangular wave drive signal having an amplitude of 2Vπ (Vπ is a half wave voltage indicating drive amplitudes corresponding to adjacent maximum transmittance and minimum transmittance) corresponding to one cycle of the light transmission characteristic of the light intensity modulator is applied, thereby generating a light pulse having an arbitrary pulse width with less chirp (Patent Literature 1).

### CITATION LIST

### Patent Literature

Patent Literature 1: JP 3524005 B2

### SUMMARY OF INVENTION

### Technical Problem

However, in the method disclosed in Patent Literature 1, the peak of the light transmission characteristic of the light intensity modulator may shift due to the device environment or application of a large voltage. If such a change is caused, there is a problem that a noise component (hereinafter referred to as inter-pulse phase component) occurs between light pulses, and the SN ratio deteriorates. In addition, in a case where the repetition frequency of the light pulse is changed, since Vπ changes, the amplitude of the drive signal is different, and an inter-pulse phase component occurs.

The present invention has been made in view of this kind of problem, and an object of the present invention is to provide a light pulse generation device and a generation method capable of suppressing occurrence of an inter-pulse phase component and stably generating a short pulse with less phase chirp due to wavelength fluctuation.

### Solution to Problem

A light pulse generation device according to one aspect of the present invention includes: a light intensity modulator that outputs light pulses in which a signal intensity of a photocarrier output by a light source is modulated in accordance with a magnitude of a drive signal around an operation bias point; a measurement unit that measures an inter-pulse phase component that is an amplitude between the light pulses; a bias control unit that controls the operation bias point on the basis of a magnitude of the inter-pulse phase component; and a drive signal control unit that controls the magnitude of the drive signal on the basis of the magnitude of the inter-pulse phase component.

Further, a light pulse generation method according to one aspect of the present invention includes: a light intensity modulation step of outputting light pulses in which a signal intensity of a photocarrier output by a light source is modulated in accordance with a magnitude of a drive signal around an operation bias point; a measurement step of measuring an inter-pulse phase component that is an amplitude between the light pulses; a bias control step of controlling the operation bias point on the basis of a magnitude of the inter-pulse phase component; and a drive signal control step of controlling the magnitude of the drive signal on the basis of the magnitude of the inter-pulse phase component.

### Advantageous Effects of Invention

According to the present invention, it is possible to provide a light pulse generation device and a generation method capable of suppressing occurrence of noise and stably generating a short pulse with less phase chirp due to wavelength fluctuation.

### BRIEF DESCRIPTION OF DRAWINGS

FIG. 1 is a block diagram illustrating a configuration example of a light pulse generation device according to an embodiment of the present invention.

FIG. 2 is a diagram schematically illustrating an operation of a light intensity modulator illustrated in FIG. 1.

FIG. 3 is a flowchart illustrating a processing procedure of a process of adjusting a light pulse.

FIG. 4 is a diagram schematically illustrating an example of a light pulse generated in the process of adjusting a light pulse.

FIG. 5 is a diagram schematically illustrating another example of the light pulse illustrated in FIG. 4.

FIG. 6 is a diagram schematically illustrating a specific configuration example of the light pulse generation device illustrated in FIG. 1.

FIG. 7 is a diagram schematically illustrating a modified example of a measurement unit illustrated in FIG. 6.

FIG. 8 is a block diagram illustrating a schematic configuration example of a quantum communication system including a transmitter and a receiver using the light intensity modulator illustrated in FIG. 1.

FIG. 9 is a flowchart illustrating a processing procedure for transmitting a test signal.

FIG. 10 is a time chart schematically illustrating a relationship between communication data and a test signal output from the transmitter illustrated in FIG. 8.

### DESCRIPTION OF EMBODIMENTS

Hereinafter, an embodiment of the present invention will be described with reference to the drawings. The same components in the plurality of drawings will be denoted with the same reference numerals, and a description thereof will be omitted.

### (Configuration of Light Pulse Generation Device)

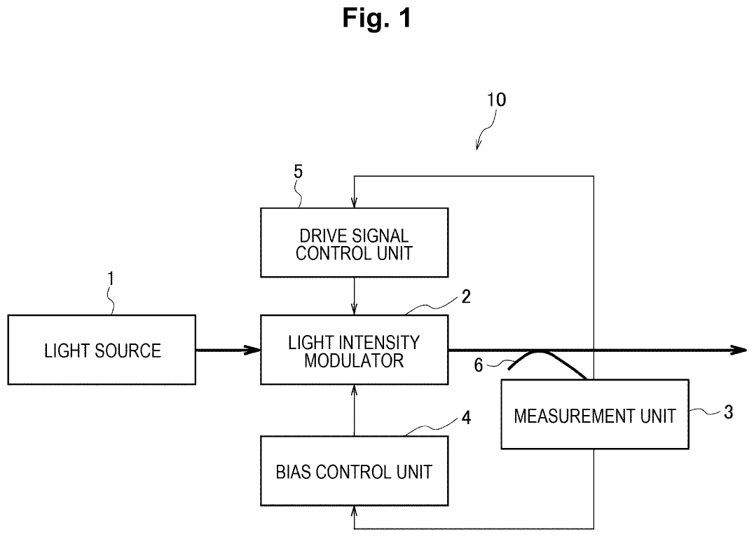

FIG. 1 is a block diagram illustrating a configuration example of a light pulse generation device according to an embodiment of the present invention. A light pulse generation device 10 illustrated in FIG. 1 generates light pulses used for optical communication, light measurement, and the like.

The light pulse generation device 10 includes a light source 1, a light intensity modulator 2, a measurement unit 3, a bias control unit 4, and a drive signal control unit 5. In FIG. 1, a thick line represents a path of an optical signal, and a thin line represents a path of an electric signal.

The light source 1 outputs photocarriers. The light source 1 is constituted by a semiconductor laser, for example. Photocarriers are signals that form a light pulse, and a maximum value of the photocarriers forms a peak value of the light pulse. Note that the light source 1 may be omitted. The light source 1 is not necessary if photocarriers are supplied from the outside.

The light intensity modulator 2 sets an operation bias point such that the transmittance of the intensity modulator is maximized, and outputs a light pulse in which the signal intensity of the photocarriers output from the light source 1 is modulated in correspondence with the magnitude of the drive signal. As the light intensity modulator 2, a push-pull MZ type light intensity modulator or a directional coupler type light intensity modulator can be used.

The MZ-type light intensity modulator is configured to apply a phase difference according to the drive signal to light branched into two optical waveguides by a Y-branch waveguide on the input side, and modulate the output light intensity by using an interference effect when multiplexed by a Y-branch waveguide on the output side. The operation of modulating the output light intensity will be described later in detail.

The measurement unit 3 measures an inter-pulse phase component that is an amplitude between light pulses output from the light intensity modulator 2. An inter-pulse phase component is noise and is not output if the operation bias point of the drive signal and the amplitude of the drive signal are correctly adjusted. A specific configuration example of the measurement unit 3 will be described later.

The bias control unit 4 controls the operation bias point on the basis of the magnitude of the inter-pulse phase component measured by the measurement unit 3.

The drive signal control unit 5 controls the magnitude of the drive signal on the basis of the magnitude of the inter-pulse phase component measured by the measurement unit 3.

An optical coupler 6 branches a part of the light pulse output from the light intensity modulator 2 into the measurement unit 3. The optical coupler 6 is a general optical coupler.

### (Effect of Light Pulse Generation Device)

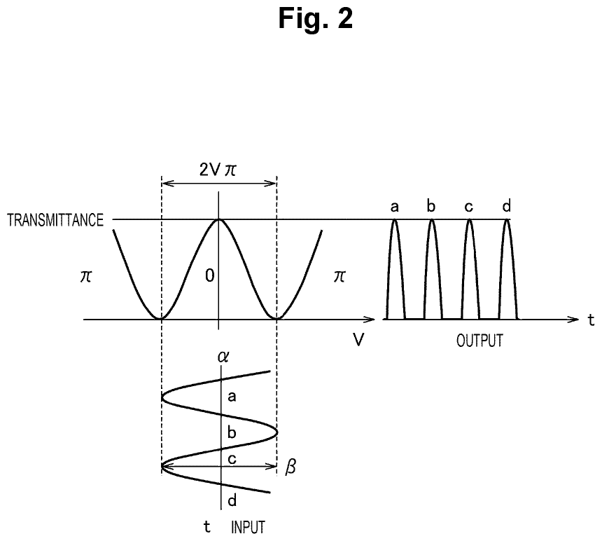

FIG. 2 is a diagram schematically illustrating an operation of the light intensity modulator 2. FIG. 2 illustrates a light pulse in a state in which there is no inter-pulse phase component.

In FIG. 2, a horizontal sine wave indicates a change in the light transmittance of the light intensity modulator 2. A longitudinal sine wave indicates a change in the drive signal applied to the light intensity modulator 2, and the right side is defined as a positive direction and the left side is defined as a negative direction. The row of high triangles (light pulses) on the right side indicates a light pulse train output from the light intensity modulator 2.

As illustrated in FIG. 2, when an intermediate potential a of the drive signal coincides with the maximum value of the transmittance of light and an amplitude β of the drive signal coincides with one cycle of the transmission characteristic of light, the inter-pulse phase component that is the amplitude between the light pulses is zero. The intermediate potential ∝ of the drive signal will be hereinafter referred to as an operation bias point ∝.

The drive signal is a signal of a frequency f having an amplitude of 2Vπ (Vπ is a half wave voltage indicating drive amplitudes corresponding to adjacent maximum transmittance and minimum transmittance) corresponding to one cycle of the transmission characteristic of the light intensity modulator 2.

A point a of the drive signal at which the amplitude of the drive signal coincides with the operation bias point a corresponds to a of the light pulse. Thereafter, similarly, points b, c, and d of the drive signal r correspond to b, c, and d of the light pulse, respectively. In addition, since the peak in the negative direction between the points a and b of the drive signal coincides with the minimum transmittance of the transmission characteristic of the light intensity modulator 2, the amplitude (inter-pulse phase component) between the light pulses a and b is zero (0). In addition, since the peak in the positive direction between the points b and c of the drive signal coincides with the minimum transmittance of the transmission characteristic of the light intensity modulator 2, the amplitude (inter-pulse phase component) between the light pulses b and c is also zero (0).

In this way, by correctly setting the operation bias point a and the amplitude β of the drive signal as illustrated in FIG. 2, a light pulse having no inter-pulse phase component of a repetition frequency 2f is output from the light intensity modulator 2.

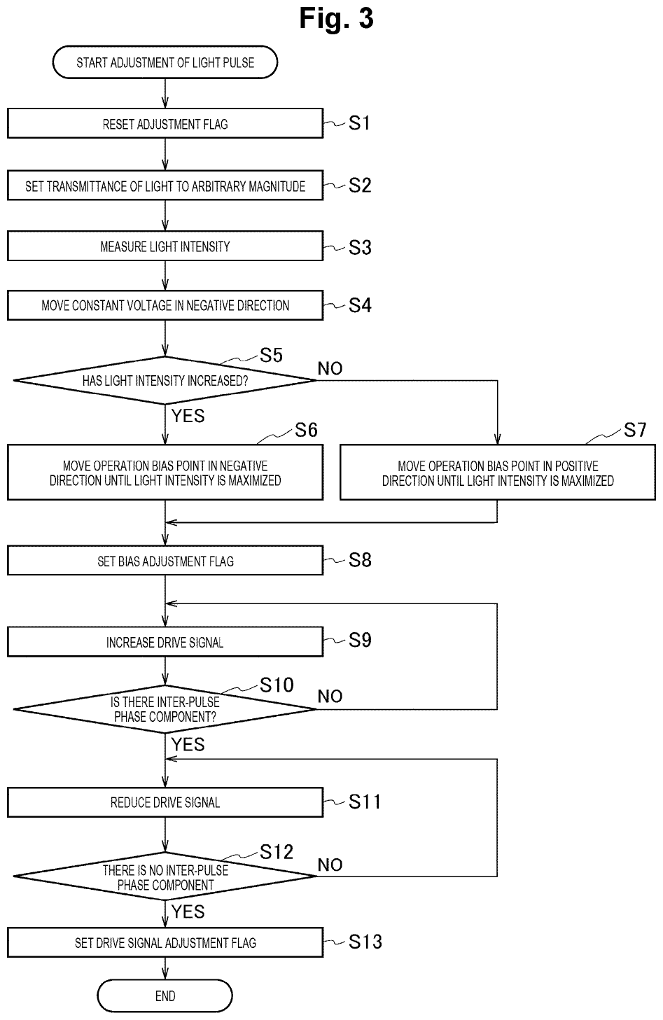

In accordance with the light pulse generation device 10 according to the present embodiment, the operation bias point a and the amplitude β can be adjusted correctly and easily. The adjustment procedure will be described with reference to FIG. 3.

FIG. 3 is a flowchart illustrating a processing procedure of a process of adjusting a light pulse. The main entity performing each step of this flowchart is each of the measurement unit 3, the bias control unit 4, and the drive signal control unit 5.

When the process of adjusting a light pulse starts, the bias control unit 4 resets a bias adjustment flag indicating that the operation bias point has been adjusted. Further, the drive signal control unit 5 resets a drive signal adjustment flag. In short, the adjustment flag is reset before adjustment (step S1).

Next, the drive signal control unit 5 sets a drive signal having an arbitrary intermediate magnitude in which the transmission characteristic of the light intensity modulator 2 is not maximized or minimized (step S2). The drive signal at this time is a constant voltage having an arbitrary magnitude within the range of the amplitude β.

Next, the measurement unit 3 measures the light intensity of the photocarriers output from the light intensity modulator 2 with the constant voltage (step S3).

Next, the drive signal control unit 5 moves the constant voltage of the drive signal set in step S2 in the negative direction (step S4).

Next, the measurement unit 3 measures the light intensity of the photocarriers output from the light intensity modulator 2. Then, the bias control unit 4 compares the light intensity measured in step S3 with the light intensity measured in step S4 (step S5).

If the comparison result indicates that the light intensity has increased (YES in step S5), it can be seen that the drive signal set in step S2 is a voltage on the positive side of the intermediate voltage having the amplitude β. In this case, the bias control unit 4 moves the voltage of the drive signal in the negative direction such that the light intensity of the photocarriers output from the light intensity modulator 2 is maximized (step S6).

If the comparison result indicates that the light intensity has decreased (NO in step S5), it can be seen that the drive signal set in step S2 is a voltage on the negative side of the intermediate voltage having the amplitude β. In this case, the bias control unit 4 moves the voltage of the drive signal in the positive direction such that the light intensity of the photocarriers output from the light intensity modulator 2 is maximized (step S7).

The bias control unit 4 sets the constant voltage at which the light intensity of the photocarriers is maximized as the operation bias point ∝ and sets the bias adjustment flag (step S8). Setting of the bias adjustment flag indicates the end of adjustment of the operation bias point a.

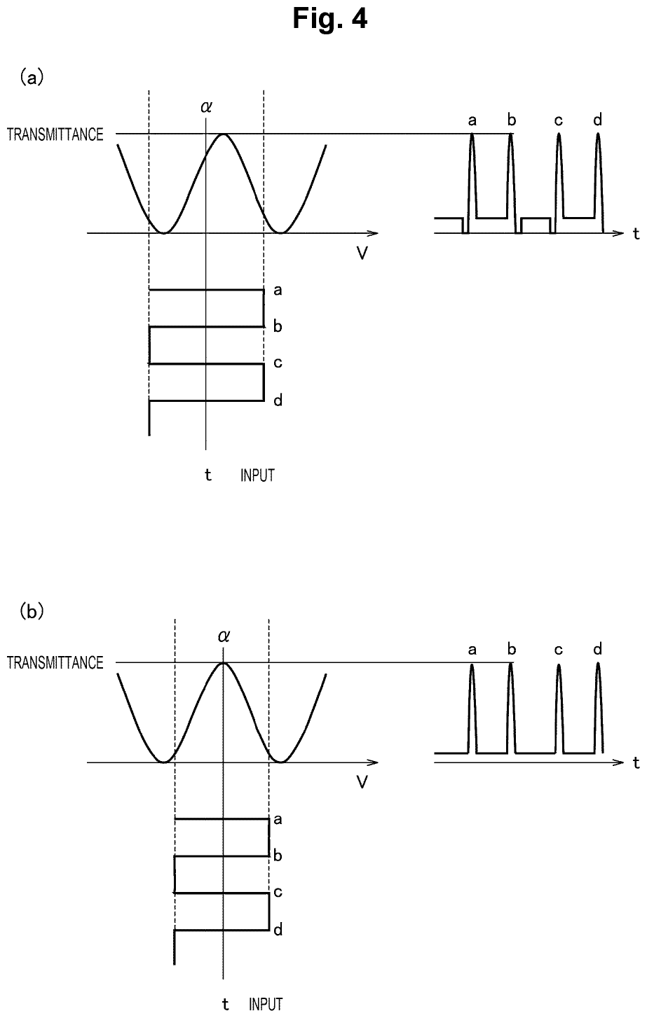

FIG. 4 is a diagram schematically illustrating how the bias control unit 4 adjusts the operation bias point ∝. In FIG. 4, for the purpose of easy understanding, the drive signal is represented by a rectangular wave having a frequency f. Note that the drive signal in step S7 is a DC voltage.

FIG. 4(a) indicates that the operation bias point a is located on the left side of the maximum value of the transmission characteristic of the light intensity modulator 2. The drive signal of this example is a rectangular wave having an amplitude smaller than an amplitude between the maximum value and the minimum value of the transmission characteristic of the light intensity modulator 2 with the operation bias point ∝ as the center before adjustment. The rectangular wave is used for ease of drawing.

As illustrated in FIG. 4(a), due to a change in the drive signal at time point a of the drive signal, the transmittance of the light intensity modulator 2 changes in a short time in the order of a small transmittance having a phase different by n, 0 transmittance, maximum transmittance, and a transmittance having a small reference phase (0). Due to this change in transmittance, the light pulse changes to small amplitude, 0 amplitude, maximum amplitude (a), and small amplitude. The last small amplitude is maintained for the pulse width of the drive signal.

Subsequently, due to a change in the drive signal at time of b of the drive signal, the transmittance of the light intensity modulator 2 changes in a short time in the order of the small transmittance of the reference phase (0), maximum transmittance, the small transmittance of the reference phase (0), and the small transmittance in which the phase is changed by n. Due to this change in transmittance, the light pulse changes to small amplitude, maximum amplitude (a), 0 amplitude, and small amplitude. The last small amplitude is maintained until time c of the drive signal. This is repeated hereinafter.

FIG. 4(b) indicates that the operation bias point xx coincides with the maximum value of the transmission characteristic of the light intensity modulator 2. Note, however, that the magnitude of the amplitude β of the drive signal is smaller than the amplitude between the maximum value and the minimum value of the transmission characteristic of the light intensity modulator 2.

In this case, as illustrated in FIG. 4(b), the light intensity of the peak of the light pulse coincides with the maximum value of the photocarriers. Note, however, that since the amplitude of the drive signal is small, the hem part of the light pulse does not decrease to zero.

As described above, when the driving amplitudes are the same, the peak light intensity of the light pulse is the same even if the operation bias point ∝ does not coincide with the peak of the transmission characteristic. However, when the driving voltage is set to a driving signal having an arbitrary intermediate magnitude in which the transmission characteristic of the light intensity modulator 2 is not maximized (the driving voltage is 0) or minimized, and the operation bias point ∝ matches the maximum value of the transmission characteristic of the light intensity modulator 2, the light intensity of the peak of the light pulse matches the maximum value of the photocarriers. That is, the bias control unit 4 performs control to set the operation bias point a to the maximum value of the transmission characteristic of the light intensity modulator 2. As a result, the light intensity of the peak of the light pulse can be increased, and the SN ratio of the light pulse can be enhanced.

As described above, the operation bias point ∝ can be adjusted by adjusting only a voltage value of the drive signal. Note that as illustrated in FIG. 4(b), if the amplitude of the drive signal is not correct even if the operation bias point ∝ is correctly adjusted, an inter-pulse phase component is output to a part between the light pulses where the amplitude should originally be 0. Therefore, next, the magnitude of the amplitude β of the drive signal is adjusted.

An operation of the drive signal control unit 5 will be described by referring back to FIG. 3. The drive signal control unit 5 of this example starts an operation after the bias control unit 4 adjusts the operation bias point ∝.

The drive signal control unit 5 increases the amplitude β of the drive signal which is smaller than the amplitude between the maximum value and the minimum value of the transmission characteristic of the light intensity modulator 2 (step S9). In this state, as illustrated in FIG. 4(b), an inter-pulse phase component occurs between light pulses.

After the inter-pulse phase component disappears once, the drive signal control unit 5 increases the amplitude β of the drive signal until the inter-pulse phase component is generated again (loop of NO in step S10).

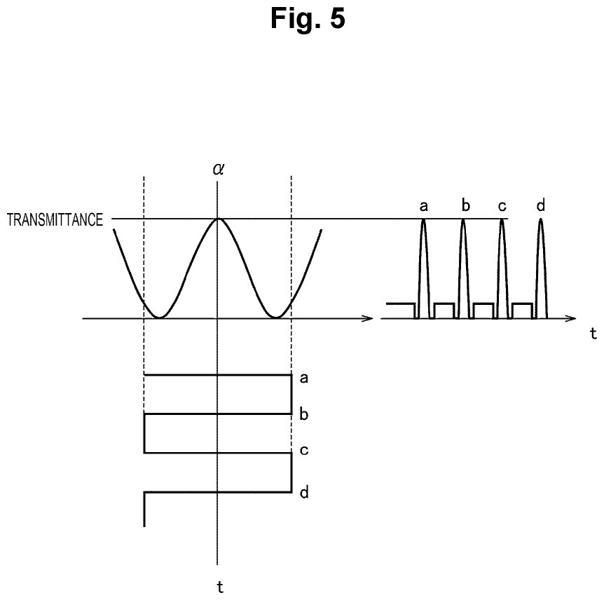

FIG. 5 is a diagram schematically illustrating a relationship between the drive signal and the light pulse in a state where the amplitude β of the drive signal is increased until the inter-pulse phase component occurs again (YES in step S10).

As illustrated in FIG. 5, the amplitude β of the drive signal is larger than the amplitude between the maximum value and the minimum value of the transmission characteristic of the light intensity modulator 2. As a result, both inter-pulse phase components having a phase different by n occur between the light pulses with phase 0 of the transmission characteristic of the light intensity modulator 2 as the center.

In the state illustrated in FIG. 5 (YES in step S10), since the amplitude β of the drive signal is too large, the drive signal control unit 5 reduces the amplitude β of the drive signal (step S11). The amplitude β is reduced until there is no inter-pulse phase component (loop of NO in step S12).

The drive signal control unit 5 stops the change in the amplitude β immediately after the disappearance of the inter-pulse phase component and sets the drive signal adjustment flag (step S13).

In this way, the drive signal control unit 5 controls the drive signal such that the amplitude of the drive signal is twice the amplitude between the maximum value and the minimum value of the transmission characteristic of the light intensity modulator 2. As a result, the amplitude of the light pulse can be maximized, and the SN ratio can be enhanced.

As described above, the light pulse generation device 10 according to the present embodiment includes the light intensity modulator 2 that outputs a light pulse in which the signal intensity of photocarriers output by the light source 1 is modulated in accordance with the magnitude of the drive signal with the operation bias point ∝ as the center, the measurement unit 3 that measures an inter-pulse phase component that is the amplitude between light pulses, the bias control unit 4 that controls the operation bias point a on the basis of the magnitude of the inter-pulse phase component, and the drive signal control unit 5 that controls the magnitude of the drive signal on the basis of the magnitude of the inter-pulse phase component. As a result, occurrence of noise can be suppressed, and a short pulse with less phase chirp due to wavelength fluctuation can be generated stably.

Further, a light pulse generation method performed by the light pulse generation device 10 includes a light intensity modulation step of outputting a light pulse in which signal intensity of photocarriers output from a light source is modulated in accordance with the magnitude of a drive signal with an operation bias point as the center, an inter-pulse phase component measurement step of measuring an inter-pulse phase component that is an amplitude between light pulses, a bias controlling step (S1 to S8 in FIG. 3) of controlling the operation bias point a on the basis of the magnitude of the inter-pulse phase component, and a drive signal controlling step (S9 to S13 in FIG. 3) of controlling the magnitude of the drive signal on the basis of the magnitude of the inter-pulse phase component.

Further, fine adjustment of the operation bias point a can be performed by measuring the inter-pulse phase component. For example, in the case of FIG. 4(a), the phase component between the pulse a and the pulse b is the same as the reference phase (0), the phase component between the pulse b and the pulse c is different by II, and 0 and π are repeated for each pulse. In FIG. 4(b), the phase component between the pulse a and the pulse b is 0, and the phase component between the pulse b and the pulse c is also 0. By measuring the phase component between pulses, in a case where 0 and π are repeated, the bias can be adjusted without changing the driving voltage by controlling the operation bias point a such that the noise is 0 or the inter-pulse phase component is only a component of 0.

### Specific Configuration Example

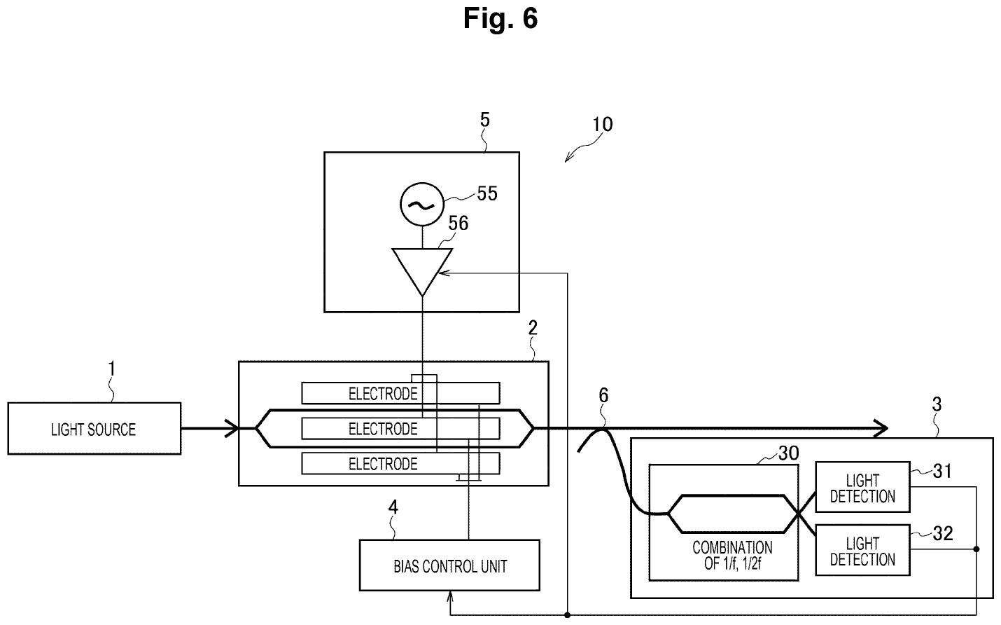

FIG. 6 is a diagram schematically illustrating a specific configuration example of the light pulse generation device 10.

As illustrated in FIG. 6, the light intensity modulator 2 may be constituted by an MZ type light intensity modulator, for example.

The light intensity modulator 2 constituted by the MZ-type light intensity modulator branches photocarriers input from the light source 1 into two optical waveguides 22a and 22b by a Y-branch waveguide 21. Then, a phase difference corresponding to the applied voltage (voltage of the drive signal) is applied to the branched light, and the output light intensity is modulated using an interference effect at the time of multiplexing in a Y-branch waveguide 23 to output a light pulse train. The light pulse train is output to the outside, and a part thereof is input to the measurement unit 3 via the optical coupler 6.

The measurement unit 3 includes a phase separation unit 30 that extracts an inter-pulse phase component, and light intensity measurement units 31 and 32 that measure the intensity of the optical signal output from the phase separation unit 30.

The phase separation unit 30 can be constituted by an MZ type light intensity modulator including two optical waveguides that delay a time corresponding to a cycle of 1/f, that is, a n phase. The phase separation unit 30 is different in that it does not apply a voltage to the electrodes, but is the same as the MZ type light intensity modulator forming the light intensity modulator 2.

The phase separation unit 30 extracts an inter-pulse phase component that is an amplitude between light pulses.

The inter-pulse phase component is converted into an electric signal by the light intensity measurement units 31 and 32. The light intensity measurement units 31 and 32 are photoelectric elements such as photodiodes and phototransistors.

The bias control unit 4 controls the operation bias point a on the basis of the magnitude of the inter-pulse phase component.

The drive signal control unit 5 amplifies a signal of the frequency f output from an oscillator 55 using an amplifier 56, on the basis of the magnitude of the inter-pulse phase component and controls the magnitude of the amplitude β of the drive signal.

The method of controlling the operation bias point ∝ and the drive signal is performed using the procedure described in FIG. 3.

### Modified Example of Phase Separation Unit

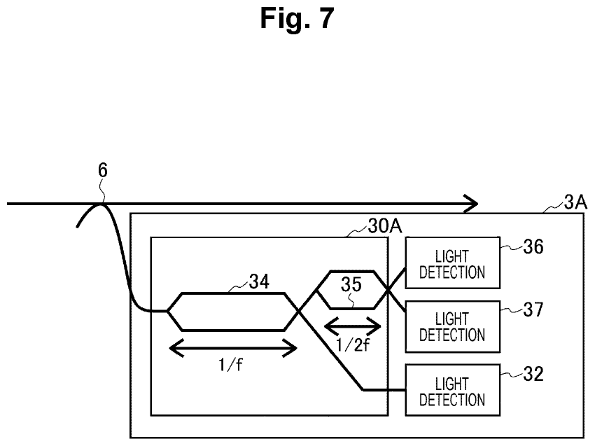

FIG. 7 is a diagram schematically illustrating a modified example of the measurement unit (FIG. 6).

As illustrated in FIG. 7, a measurement unit 3A of the modified example is different in that a phase separation unit 30A is constituted by cascade connection of a first MZ type interferometer 34 and a second MZ type interferometer 35. The first MZ type interferometer 34 delays a time (1/f) of one cycle of the frequency f of the light pulse.

The second MZ type interferometer 35 delays a time of a cycle of ½ of the frequency f of the light pulse. The second MZ type interferometer 35 is connected to a first output (upper side in FIG. 7) of the first MZ type interferometer 34 instead of the light intensity measurement unit 31.

A light intensity measurement unit 36 is connected to the first output (upper side) of the second MZ type interferometer 35, and a light intensity measurement unit 37 is connected to the second output (lower side) of the second MZ type interferometer 35. The light intensity measurement unit 32 is connected to the second output (lower side) of the first MZ type interferometer 34.

In this way, the phase separation unit 30 may include the first MZ type interferometer 34 that delays a time of one cycle of the frequency f of the light pulse and the second MZ type interferometer 35 that is connected to the output of the first MZ type interferometer 34 and delays a time of a cycle of ½ of the frequency f. In the case of this configuration, if the amplitude β of the drive signal is small after the adjustment of the operation bias point a, the output of the light intensity measurement unit 37 becomes small. In the same case, when the amplitude β of the drive signal is large, the output of the light intensity measurement unit 36 becomes small. The magnitude of the amplitude β of the drive signal can be adjusted by confirming these changes.

In this way, due to the phase separation unit 30 being constituted by an optical device such as the MZ type light intensity modulator, the light pulse generation device can be configured more easily than the configuration in which the inter-pulse phase component is extracted using an electronic circuit, and the cost thereof can be reduced.

### (Application)

An optical communication system is one of applications of utilization of high-repetition short pulses.

Since the pulse spreads due to the influence of dispersion of fiber, it can be utilized as a light source for return-to-zero (RZ) modulation having a small duty ratio. By making the repetition frequency variable, the communication rate can be changed according to the demand. In addition, application as a light source of fiber sensing is also conceivable. Measurement resolution can be enhanced by using a pulse having a high repetition rate and a small duty ratio. Further, by making the repetition frequency variable, the position of the measuring fiber can be swept over a wide range.

In addition, in quantum communication such as quantum cryptography, since the sensitivity of the measuring instrument is high, a dark count occurs where an erroneous count of a signal occurs even if a signal has not been received. In order to suppress dark counts, a pulse having a small duty ratio is required.

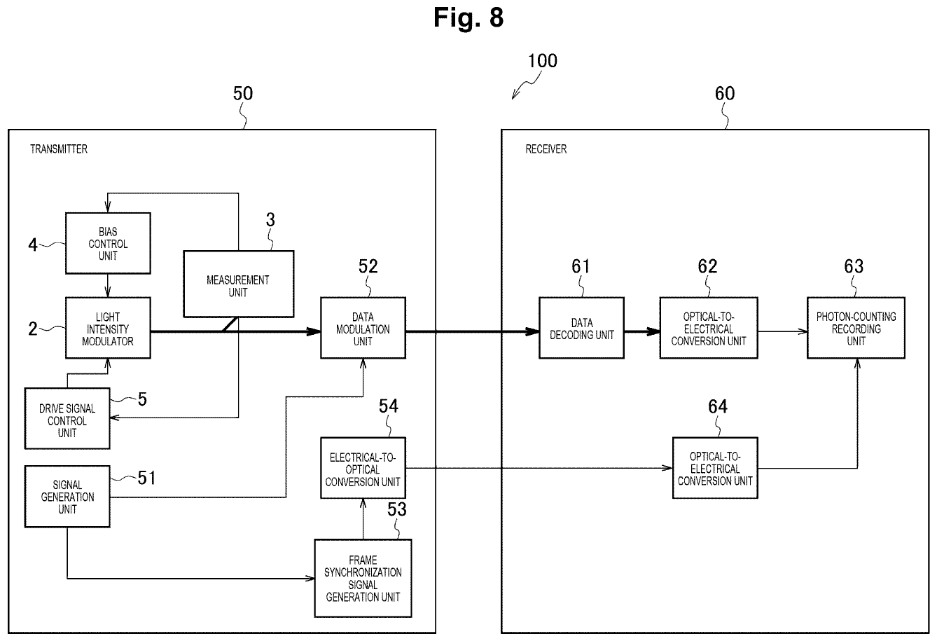

FIG. 8 is a block diagram illustrating a schematic configuration example of an optical communication system. An optical communication system 100 illustrated in FIG. 8 includes a transmitter 50 using the light pulse generation device 10 according to the present embodiment and a receiver 60. In the light pulse generation device 10 included in the transmitter 50, the light source 1 is omitted

The transmitter 50 includes, a signal generation unit 51, a data modulation unit 52, a frame synchronization signal generation unit 53, and an electrical-to-optical conversion unit 54, in addition to the light pulse generation device 10.

The signal generation unit 51 generates communication data and a test signal indicating that the light pulse generation device 10 is performing adjustment. Here, “performing adjustment” means that either a drive signal control step (S9 to S13 in FIG. 3) or a bias control step (S1 to S8 in FIG. 3) is being performed.

The data modulation unit 52 modulates the light pulse on the basis of the communication data. Examples of the modulation scheme include intensity, polarization, and phase. An optical signal attenuates to one photon or less per light pulse and is transmitted to the reception side.

In quantum communication, most photons are lost by transmission of fiber, and therefore a frame header or the like may not be sent together with data. Therefore, a frame synchronization signal is transmitted through a different path from the data or by wavelength multiplexing. The frame synchronization signal generation unit 53 generates a frame synchronization signal indicating the head of the communication data.

Information indicating the position of the test signal may be inserted together with the frame synchronization signal of the present embodiment.

The electrical-to-optical conversion unit 54 converts the frame synchronization signal into an optical signal and outputs the optical signal to the receiver 60.

The receiver 60 includes a data decoding unit 61, an optical-to-electrical conversion unit 62, a photon-counting recording unit 63, and an optical-to-electrical conversion unit 64.

The data decoding unit 61 demodulates the communication data whose phase has been modulated by the transmitter 50.

The optical-to-electrical conversion unit 62 converts the demodulated communication data into an electric signal. The optical-to-electrical conversion unit 62 is an avalanche photodiode for photon measurement or a superconducting photon measuring device, for example.

The photon-counting recording unit 63 records the communication data converted into the electric signal.

The optical-to-electrical conversion unit 62 converts the frame synchronization signal transmitted from the transmitter 50 into an electric signal. The frame synchronization signal converted into an electric signal is output to the photon-counting recording unit 63. The photon-counting recording unit 63 records the time from the frame synchronization signal to detection of photons.

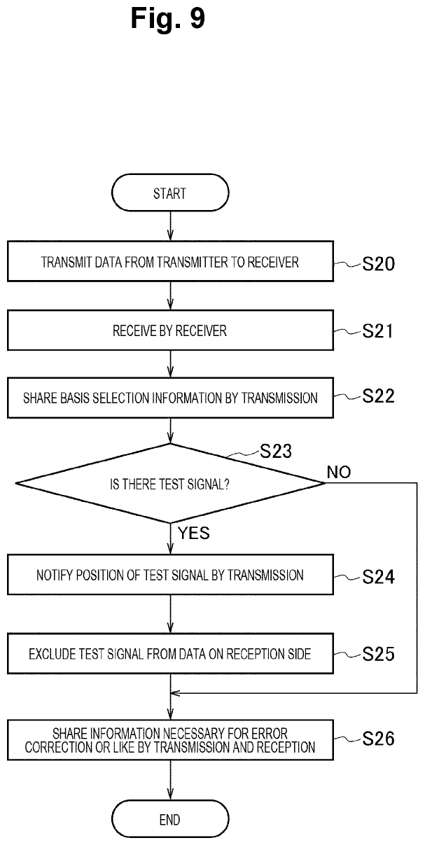

FIG. 9 is a flowchart illustrating a processing procedure for transmitting a test signal.

When the optical communication system 100 starts communication, communication data is transmitted from the transmitter 50 to the receiver 60 (step S20).

The communication data is received by the receiver 60 (step S21).

The receiver 60 decodes header information of the communication data and shares basis selection information with the transmitter 50 (step S22). Basis selection information is, for example, phase information and time information used for measurement by the receiver 60.

The receiver 60 may acquire whether there is a test signal from the transmitter 50 in step S22, or determines whether a test signal is included in communication data by acquiring the position of the head of the test signal from a frame synchronization signal as illustrated in FIG. 8 (step S23).

If the data includes a test signal, the receiver 60 acquires a data range used for the test signal in step S22. Alternatively, it is possible to know the position of the test signal in the communication data from a frame synchronization signal (step S24).

The receiver 60 excludes the test signal from the communication data (step S25). Alternatively, the receiver 60 deletes the communication data including the test signal. For example, if the data range is known, data from the frame synchronization signal to the data range is decoded as data.

Thereafter, for example, information such as an error correction code or the like is shared, and the communication data is correctly decoded (step S26).

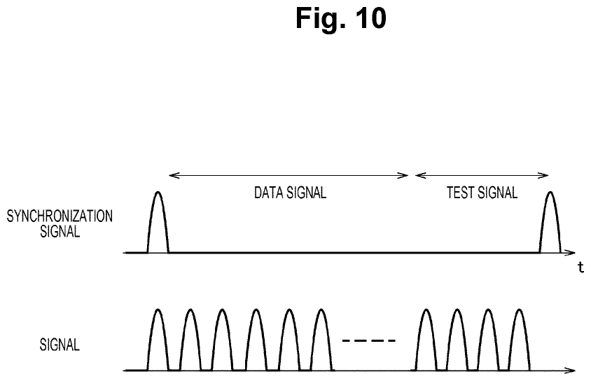

FIG. 10 is a time chart schematically illustrating a relationship between communication data and a test signal output from the transmitter. As illustrated in FIG. 10, the communication data and the test signal are output in time series.

As described above, in an optical data communication method according to the present embodiment, the following are performed: a test signal transmission step (step S20) of transmitting, to the receiver, a test signal indicating that either the drive signal control step or the bias control step is being performed and a test signal notification step (step S24) of notifying the receiver of a start position of the test signal. As a result, the receiver 60 can prevent an increase in errors due to unadjusted light pulses.

In addition, since the light pulse generation device 10 can perform adjustment at an arbitrary timing by transmitting a test signal, it is possible to always suppress occurrence of noise and stably generate a short pulse with less phase chirp due to wavelength fluctuation.

As described above, an inter-pulse phase component that is the amplitude between light pulses is extracted using an optical device such as the MZ type light intensity modulator, and the operation bias point ∝ of the light intensity modulator 2 and the magnitude of the amplitude β of the drive signal are controlled such that the inter-pulse phase component does not occur, whereby noise can be suppressed. Therefore, stable optical communication can be performed with a light pulse having a good SN ratio.

In addition, since the receiver is notified of a test signal indicating that the light pulse is being adjusted or unadjusted, communication with an unstable light pulse can be prevented.

Note that although FIG. 6 illustrates an example in which the light intensity modulator 2 and the phase separation unit 30 of the measurement unit 3 are constituted by separate MZ type light intensity modulators, the present invention is not limited to this example. The light intensity modulator 2 and the phase separation unit 30 may be arranged on the same chip. Stability against disturbance such as temperature change can be enhanced. In addition, a directional coupler type light intensity modulator may be used instead of the MZ type light intensity modulator.

As described above, it is needless to say that the present invention includes various embodiments and the like not described herein. Therefore, the technical scope of the present invention is defined only by matters specifying the invention according to the valid scope of claims based on the above description.

### REFERENCE SIGNS LIST

1 Light source
2 Light intensity modulator
3, 3A Measurement unit
4 Bias control unit
5 Drive signal control unit
10 Light pulse generation device
30, 30A Phase separation unit
31, 32, 36, 37 Light intensity measurement unit
34 First Mach-Zehnder interferometer
35 Second Mach Zehnder interferometer

1. A light pulse generation device comprising:
a light intensity modulator that outputs light pulses in which a signal intensity of a photocarrier output by a light source is modulated in accordance with a magnitude of a drive signal with an operation bias point as the center;
a measurement unit that measures an inter-pulse phase component that is an amplitude between the light pulses;
a bias control unit that controls the operation bias point on the basis of a magnitude of the inter-pulse phase component; and
a drive signal control unit that controls the magnitude of the drive signal on the basis of the magnitude of the inter-pulse phase component.

2. The light pulse generation device according to claim 1, wherein
the drive signal control unit controls the drive signal such that an amplitude of the drive signal is twice an amplitude between a maximum value and a minimum value of a transmission characteristic of the light intensity modulator.

3. The light pulse generation device according to claim 1, wherein
the bias control unit performs control to set the operation bias point to the maximum value of the transmission characteristic of the light intensity modulator.

4. The light pulse generation device according to claim 1, wherein
the measurement unit includes
a phase separation unit that extracts the inter-pulse phase component, and
a light intensity measurement unit that measure an intensity of an optical signal output by the phase separation unit.

5. The light pulse generation device according to claim 4, wherein
the phase separation unit includes
a Mach-Zehnder interferometer to which the light pulse is input.

6. The light pulse generation device according to claim 5, wherein
the Mach-Zehnder interferometer includes
a first Mach-Zehnder interferometer that delays a time of one cycle of a frequency of the light pulse, and
a second Mach-Zehnder interferometer that is connected to an output of the first Mach-Zehnder interferometer and delays a time of a cycle of ½ of the frequency.

7. A light pulse generation method comprising:
a light intensity modulation step of outputting light pulses in which a signal intensity of a photocarrier output by a light source is modulated in accordance with a magnitude of a drive signal with an operation bias point as the center;
a measurement step of measuring an inter-pulse phase component that is an amplitude between the light pulses;
a bias control step of controlling the operation bias point on the basis of a magnitude of the inter-pulse phase component; and
a drive signal control step of controlling the magnitude of the drive signal on the basis of the magnitude of the inter-pulse phase component.

8. The light pulse generation method according to claim 7, comprising:
a test signal transmission step of transmitting, to a receiver, a test signal indicating that either the drive signal control step or the bias control step is being performed; and
a test signal notification step of notifying the receiver of a start position of the test signal.
